(19) United States
(12) Patent Application Publication
(10) Pub. No.: US 2019/0073727 A1
(43) Pub. Date: Mar. 7, 2019

(54) RECORDING MEDIUM HAVING STORED SETTLEMENT PROGRAM

(71) Applicant: FUJITSU LIMITED, Kawasaki-shi (JP)

(72) Inventors: Xin Wang, Ota (JP); Hiroko Yuki, Yokohama (JP); Masahiro Usui, Yokohama (JP)

(73) Assignee: FUJITSU LIMITED, Kawasaki-shi (JP)

(21) Appl. No.: 16/177,803

(22) Filed: Nov. 1, 2018

Related U.S. Application Data
(63) Continuation of application No. PCT/JP2016/068580, filed on Jun. 22, 2016.

(51) Int. Cl. G06Q 40/00; G06Q 20/12; G06Q 20/04

(52) U.S. Cl. CPC G06Q 40/12; G06Q 20/045; G06Q 20/12

(57) ABSTRACT

A non-transitory computer-readable recording medium recording a settlement program for causing a computer to execute a process, the process includes: receiving, from an information processing terminal, a control signal that specifies, depending on a determination result about whether a product to be purchased corresponds to a specific product, a specific piece of balance management information to be used for a deduction transaction for the specific product, as a deduction transaction target to deduct an amount corresponding to the product to be purchased from among multiple pieces of balance management information; determining a piece of balance management information identified based on the received control signal, by referring to a storage which stores the multiple pieces of balance management information; and executing a deduction transaction for the amount corresponding to the product to be purchased, using the determined piece of balance management information.

### CROSS-REFERENCE TO RELATED APPLICATION

This application is a continuation application of International Application PCT/JP2016/068580 filed on Jun. 22, 2016 and designated the U.S., the entire contents of which are incorporated herein by reference.

### FIELD

The embodiments discussed herein are related to recording mediums having stored therein a settlement program, settlement methods, and settlement apparatuses.

### BACKGROUND

There are various kinds of cash voucher.

Japanese Laid-open Patent Publication No. 2012-221130 discusses related techniques.

### SUMMARY

According to an aspect of the embodiments, a non-transitory computer-readable recording medium recording a settlement program for causing a computer to execute a process, the process includes: receiving, from an information processing terminal, a control signal that specifies, depending on a determination result about whether a product to be purchased corresponds to a specific product, a specific piece of balance management information to be used for a deduction transaction for the specific product, as a deduction transaction target to deduct an amount corresponding to the product to be purchased from among multiple pieces of balance management information; determining a piece of balance management information identified based on the received control signal, by referring to a storage which stores the multiple pieces of balance management information; and executing a deduction transaction for the amount corresponding to the product to be purchased, using the determined piece of balance management information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a schematic configuration of a system according to Embodiment 1;

FIG. 2 is a diagram for explaining a conventional problem;

FIG. 3 is a diagram schematically illustrating the flow of certification of products manufactured in a promoted region and benefit money, according to Embodiment 1;

FIG. 4 is a diagram schematically illustrating the flow of use of the benefit money, according to Embodiment 1;

FIG. 5 is a diagram illustrating an example of the configuration of a settlement apparatus according to Embodiment 1;

FIG. 6 is a diagram illustrating an example of the data structure of merchandise voucher information;

FIG. 7 is a diagram illustrating an example of the data structure of issued merchandise voucher information;

FIG. 8 is a diagram illustrating an example of the data structure of certified-product information;

FIG. 9 is a diagram schematically illustrating an example of the flow of purchase of a product using a premium merchandise voucher;

FIG. 10 is a diagram illustrating an example of a settlement operation screen;

FIG. 11 is a diagram illustrating an example of merchandise voucher list screens;

FIG. 12 is a diagram illustrating an example of recorded issued merchandise voucher information;

FIG. 13 is a flowchart illustrating the procedure of a determination process;

FIG. 14 is a flowchart illustrating the procedure of a settlement process;

FIG. 15 is a diagram schematically illustrating the flow of the benefit money for a promoted region, according to Embodiment 2;

FIG. 16 is a diagram schematically illustrating the flow of use of the benefit money according to Embodiment 2;

FIG. 17 is a diagram illustrating an example of the configuration of a settlement apparatus according to Embodiment 2;

FIG. 18 is a diagram illustrating an example of the data structure of consumer-by-consumer remaining amount information;

FIG. 19 is a diagram schematically illustrating an example of the flow of giving benefit money;

FIG. 20 is a diagram illustrating an example of the configuration of a store terminal;

FIG. 21 is a diagram illustrating a computer that executes a settlement program; and

FIG. 22 is a diagram illustrating a computer that executes a settlement request program.

### DESCRIPTION OF EMBODIMENTS

For example, examples of cash vouchers include merchandise vouchers, such as regional development promotion tickets issued by local governments and the like. Some cash vouchers are given premiums depending on whether those who use the cash vouchers meet conditions. For example, among merchandise vouchers issued by local governments or the like are what are called premium merchandise vouchers, the exchangeable values of which is increased by benefit money added by the local governments or the like when used at stores in promoted regions for regional development.

In some cases, for example, the premium merchandise vouchers do not efficiently lead to the circulation of the regional economy. For example, when the premium merchandise vouchers are used at stores in the promoted region, the exchangeable values are increased. However, there are cases where the store procures products from vendors in regions other than the promoted region. For this reason, local vendors in the region being promoted by the premium merchandise vouchers sometimes do not benefit from the benefit money, and thus this does not efficiently lead to the circulation of the regional economy in some cases. Although the premium merchandise vouchers have been described as an example, this problem tends to occur when specific promotion targets are promoted.

For example, techniques that contribute promotion of promotion targets may be provided.

Hereinafter, based on the drawings, description is provided in detail for embodiments of a settlement program, settlement method, settlement apparatus, settlement request program, settlement request method, and settlement request apparatus according to an embodiment. The embodiments do not limit this embodiment. The embodiments may be combined as long as the processing contents of those do not contradict each other. In the following, as cash vouchers, merchandise vouchers issued by local governments or the like are described as an example.

### Embodiment 1

[System Configuration]

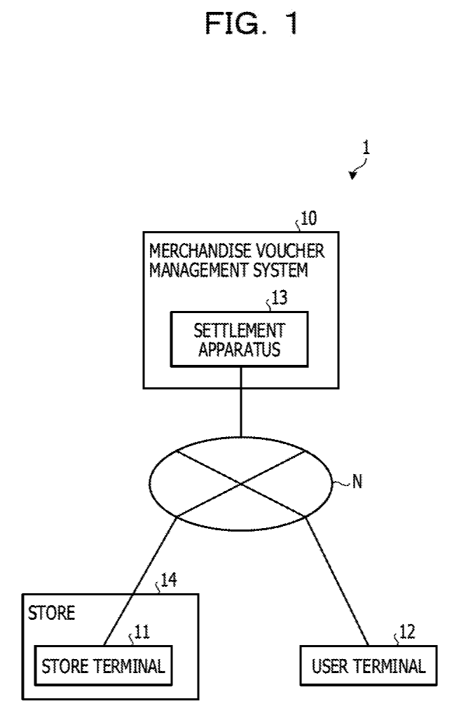

First, an example of a system 1 according to Embodiment 1 is described. FIG. 1 is a diagram illustrating an example of a schematic configuration of a system according to Embodiment 1. As illustrated in FIG. 1, the system 1 has a merchandise voucher management system 10, a store terminal 11, and a user terminal 12.

The merchandise voucher management system 10 provides the users with services related to merchandise vouchers, such as sale of the merchandise vouchers, management of the merchandise vouchers, settlement on the merchandise vouchers, and giving premiums. In this embodiment, description is provided for the case of giving benefit money to eligible people as the premium, as an example. The merchandise vouchers in this embodiment are associated with electronic information. The merchandise voucher may be, for example, data identified by a code expressed by a character string. The merchandise voucher may be, for example, a piece of paper on which a two-dimensional code, such as a QR (Quick Response) code (registered trade mark), for determining information on the merchandise voucher is printed.

The merchandise voucher management system 10 has a settlement apparatus 13. The settlement apparatus 13 is a computer that provides the users with services related to settlement on the merchandise vouchers. The settlement apparatus 13 may be implemented in one computer or may also be implemented in a computer system having multiple computers. In this embodiment, description is provided for a case where the settlement apparatus 13 is implemented in one computer, as an example.

The settlement apparatus 13 is communicably connected to the store terminal 11 and the user terminal 12 via a network N. As a form of the network N, any kind of communication network may be used, such as a local area network (LAN) or a virtual private network (VPN) whether it is wired or wireless.

The store terminal 11 is provided at a store 14 and performs settlement transactions at the store on products and the like. For example, the store terminal 11 is a POS (point of sale system) terminal. The store terminal 11 may be a mobile terminal apparatus, such as a smartphone or a tablet PC terminal or may be a computer, such as a laptop computer or a personal computer. The store terminal 11 is capable of settlement transactions on the merchandise vouchers by using the settlement apparatus 13.

The user terminal 12 is owned by a user who receives services from the merchandise voucher management system 10. For example, the user terminal 12 is a mobile terminal apparatus, such as a smartphone or a tablet PC terminal.

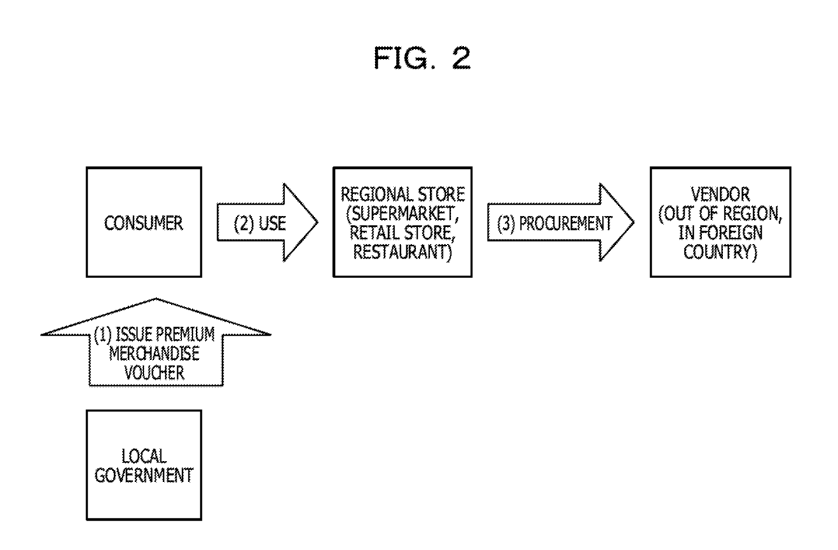

Next, giving benefit money is described. At first, a conventional problem is described. FIG. 2 is a diagram for explaining the conventional problem. A local government or the like issues premium merchandise vouchers to consumers for regional development promotion ((1) in FIG. 2). When a user uses a premium merchandise voucher at a store in the promoted region, the user may use benefit money at payment. Consumers use the premium merchandise vouchers for payment at stores such as, supermarkets, retail stores, and restaurants in the promoted region ((2) in FIG. 2). In this way, the benefit money motivates the consumers to spend money, such as shopping at stores in the promoted region. However, the stores sometimes procure products from vendors in regions other than the promoted region, such as vendors in foreign countries ((3) in FIG. 2). In this case, local vendors in the promoted region do not benefit from the benefit money, and thus the benefit money sometimes does not efficiently lead to circulation of the regional economy.

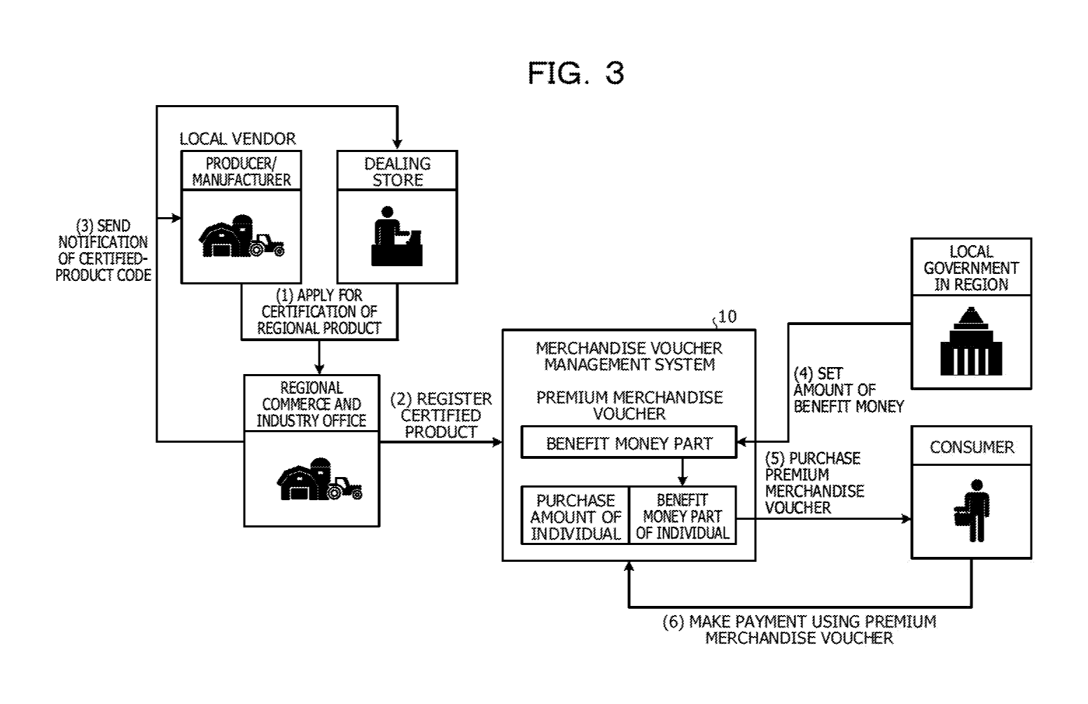

In light of the above, in Embodiment 1, the products manufactured in the promoted region are certified, and the benefit money is made applicable to the purchase of the certified products. FIG. 3 is a diagram schematically illustrating the flow of the certification of products manufactured in the promoted region and the benefit money, according to Embodiment 1. For example, a regional commerce and industry office in a promoted region receives applications for certification of regional products from producers and manufacturers that produce products in the promoted region and dealing stores that deal with products of the promoted region ((1) in FIG. 3). In the following, the producers, manufacturers, and dealing stores that produce products in the promoted region are called the “local vendors”. If an applied product is produced or manufactured in the promoted region, the regional commerce and industry office registers it as a certified product into the merchandise voucher management system 10 ((2) in FIG. 3). The merchandise voucher management system 10 issues a certified-product code for the certified product registered as a regional product. The regional commerce and industry office sends notification of the certified-product code to the local vendor who has applied for the certification ((3) in FIG. 3). The local vendor attaches a two-dimensional code, into which the certified-product code in the notification is encoded, to the certified product that has registered as a regional product to sell the product.

Meanwhile, the local government or the like sets an exchangeable value as a benefit money part into the merchandise voucher management system 10 for the regional development promotion ((4) in FIG. 3). The merchandise voucher management system 10 sells premium merchandise vouchers as digital merchandise vouchers. When a consumer purchases a premium merchandise voucher, the merchandise voucher management system 10 adds benefit money from the benefit money part and manages the figure of the sold merchandise voucher and the benefit money separately ((5) in FIG. 3). When the consumer purchases a product of the promoted region, the consumer uses the premium merchandise voucher for the payment ((6) in FIG. 3). The merchandise voucher management system 10 receives the certified-product code of the product when performing a settlement transaction for the product, using the premium merchandise voucher. If it is determined the product is a product of the promoted region from the certified-product code, the merchandise voucher management system 10 performs the settlement transaction using also the benefit money.

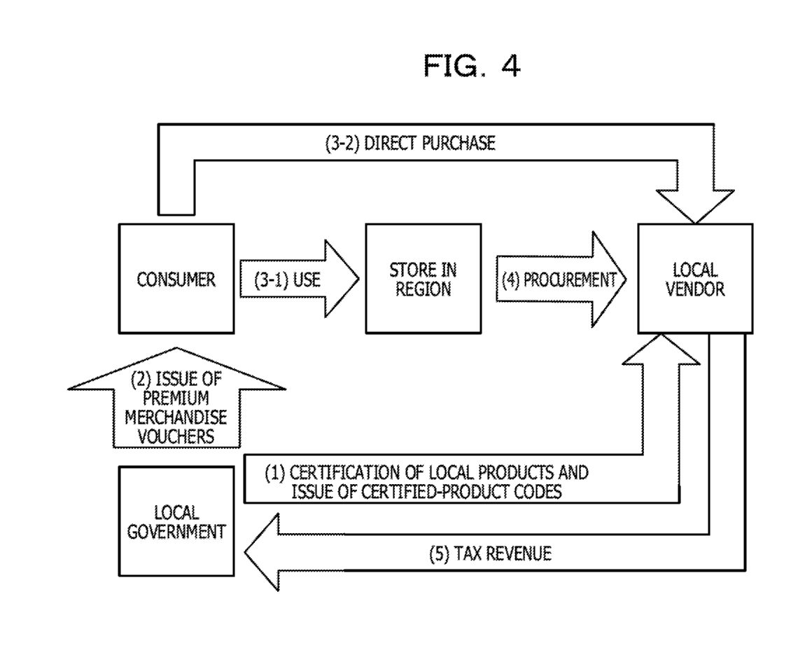

FIG. 4 is a diagram schematically illustrating the flow of use of the benefit money, according to Embodiment 1. The local government or the like certifies products of local vendors directly or via the regional commerce and industry office or other organizations and issues certified-product codes for the products ((1) in FIG. 4). The local government or the like also issues premium merchandise vouchers to consumers for regional development promotion ((2) in FIG. 4). The consumers purchase products of the promoted region using the premium merchandise vouchers at stores in the promoted region ((3-1) in FIG. 4). The stores in the promoted region procure products from local vendors ((4) in FIG. 4). The consumers may purchase products of the promoted region directly from the local vendors, using the premium merchandise vouchers ((3-2) in FIG. 4). This increases the sales volumes of products and the sales figures of the local vendors. Consequently, the tax revenue of the local governments or the like from the local vendors increases ((5) in FIG. 4). In this way, this embodiment causes the circulation in the economy of the promoted region using the benefit money, contributing to the promotion of development of the promotion target.

[Settlement Apparatus]

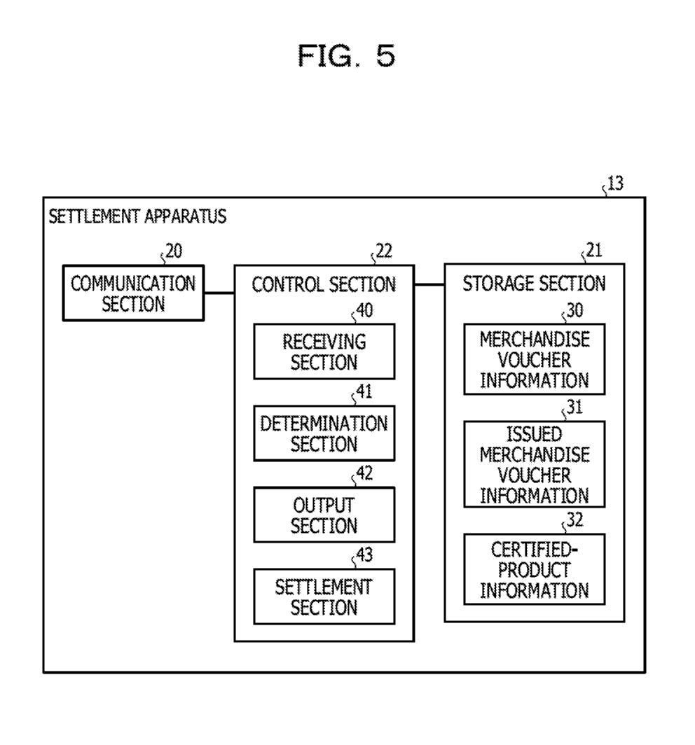

Next, description is provided for the configuration of the settlement apparatus 13 according to Embodiment 1. FIG. 5 is a diagram illustrating an example of the configuration of a settlement apparatus according to Embodiment 1. As illustrated in FIG. 5, the settlement apparatus 13 includes a communication section 20, a storage section 21, and a control section 22.

The communication section 20 is an interface that performs communication control between the settlement apparatus 13 and other apparatuses. The communication section 20 transmits and receives various kinds of information to and from other apparatuses via the network N. For the communication section 20, a network interface card, such as a LAN card, may be used.

The storage section 21 is a storage apparatus, such as a hard disk, a solid state drive (SSD), or an optical disk. The storage section 21 may be data rewritable semiconductor memory, such as random access memory (RAM), flash memory, or non-volatile static random access memory (NVSRAM). The storage section 21 may be a server apparatus, which stores and provides data.

The storage section 21 stores various programs. The storage section 21 stores various kinds of data used in the various programs. For example, the storage section 21 stores merchandise voucher information 30, issued merchandise voucher information 31, and certified-product information 32.

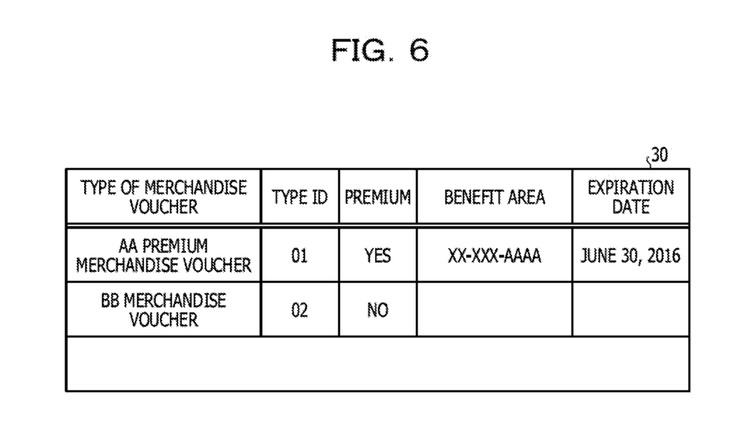

The merchandise voucher information 30 is data for storing information on merchandise vouchers managed by the merchandise voucher management system 10. Some merchandise vouchers are given premiums depending on whether the people using the merchandise vouchers satisfy conditions. For example, the exchangeable value for the premium merchandise voucher is increased by the benefit money added by the local governments or the like. For example, the merchandise voucher information 30 has information on the merchandise voucher, such as kinds of managed merchandise voucher, information on the premium, such as which has a premium and the condition for giving the premium, and other information. FIG. 6 is a diagram illustrating an example of the data structure of the merchandise voucher information. As illustrated in FIG. 6, the merchandise voucher information 30 has items such as “TYPE OF MERCHANDISE VOUCHER”, “TYPE ID”, “PREMIUM”, “BENEFIT AREA”, and “EXPIRATION DATE”. The items of the merchandise voucher information 30 illustrated in FIG. 6 are examples, and the merchandise voucher information 30 may have other items.

The item of “TYPE OF MERCHANDISE VOUCHER” is an area for storing information indicating the types of merchandise voucher managed by the merchandise voucher management system 10. The item of “TYPE ID” is an area for storing identification information indicating the type of merchandise voucher. The merchandise vouchers managed by the merchandise voucher management system 10 are given unique type IDs as the identification information for every type of merchandise voucher. The item of “TYPE ID” stores type IDs according to the kinds of merchandise voucher. The item of “PREMIUM” is an area for storing information on whether each merchandise voucher has a premium. In the item of “PREMIUM”, if a premium is given to the merchandise voucher, “YES” is stored, and if no premium is given to the merchandise voucher, “NO” is stored. The item of “BENEFIT AREA” is an area for storing information indicating the benefit area in which the benefit money is given, as a condition for giving the premium. The benefit area is an area code which hierarchically determines areas. For example, for the benefit area, a code is used in which two digits indicate a large area, three digits indicate a middle area, four digits indicate a small area, and these are connected with hyphens. In this embodiment, the area code indicating an area of benefit for the premium is determined by, for example, allocating a region of Japan, such as the Kanto region, as a large area, a prefecture as a middle area, and a municipality as a small area. The hierarchical relationship of areas may be registered in advance as master information. How to determine the area code is an example and is not limited to the above way. The item of “EXPIRATION DATE” is an area for storing information indicating the expiration date of each premium. For example, in the example illustrated in FIG. 6, for AA premium merchandise voucher, the type ID is “01”, the premium “YES”, the benefit area “XX-XXX-AAAA”, and the expiration date Jun. 30, 2016. For BB merchandise voucher, the type ID is “02”, and the premium is “NO”.

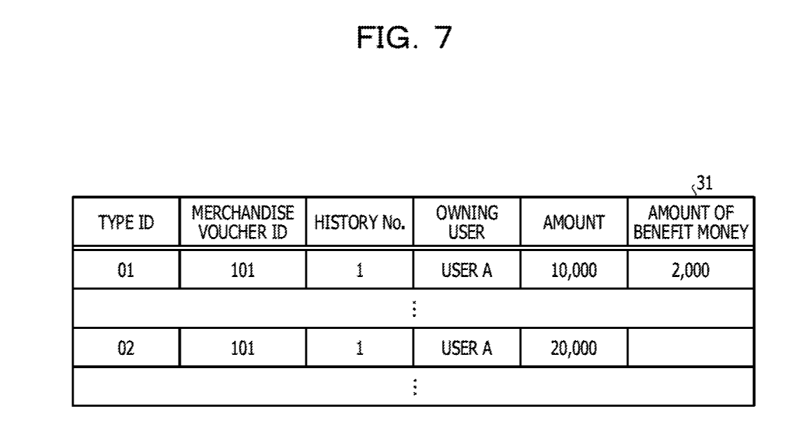

The issued merchandise voucher information 31 is data for storing history information on issued merchandise vouchers. For example, in the issued merchandise voucher information 31, the owning user of the merchandise voucher, the balance of the merchandise voucher, and the like are stored for every issued merchandise voucher. FIG. 7 is a diagram illustrating an example of the data structure of the issued merchandise voucher information. As illustrated in FIG. 7, the issued merchandise voucher information 31 has items such as “TYPE ID”, “MERCHANDISE VOUCHER ID”, “HISTORY No.”, “OWNING USER”, “AMOUNT”, and “AMOUNT OF BENEFIT MONEY”. The items of the issued merchandise voucher information 31 illustrated in FIG. 7 are examples, and the issued merchandise voucher information 31 may have other items.

The item of “TYPE ID” is an area for storing a type ID according to the type of an issued merchandise voucher. The item of “MERCHANDISE VOUCHER ID” is an area for storing identification information for identifying an issued merchandise voucher. For each issued merchandise voucher, a merchandise voucher ID is given as identification information for identifying the issued merchandise voucher. In the item of “MERCHANDISE VOUCHER ID”, the merchandise voucher ID given to the issued merchandise voucher is stored. The item of “HISTORY No.” is an area for storing the serial number of transaction histories for the merchandise voucher. The item of “OWNING USER” is an area for storing identification information on the user who has purchased the merchandise voucher and owns the merchandise voucher. The item of “AMOUNT” is an area for storing the balance of the merchandise voucher. The item of “AMOUNT OF BENEFIT MONEY” is an area for storing the balance of the benefit money provided to the merchandise voucher. For example, in the example of FIG. 7, for the merchandise voucher of which the type ID is “01” and the merchandise voucher ID is “101”, the information stored as the history No. 1 indicates that the owning user is “USER A”, the balance of the merchandise voucher is “10,000” Japanese yen, and the balance of the benefit money is “2,000” yen. For the merchandise voucher of which the type ID is “02” and the merchandise voucher ID is “101”, the information stored as the history No. 1 indicates that the owning user is “USER A”, and the balance of the merchandise voucher is “20,000” yen.

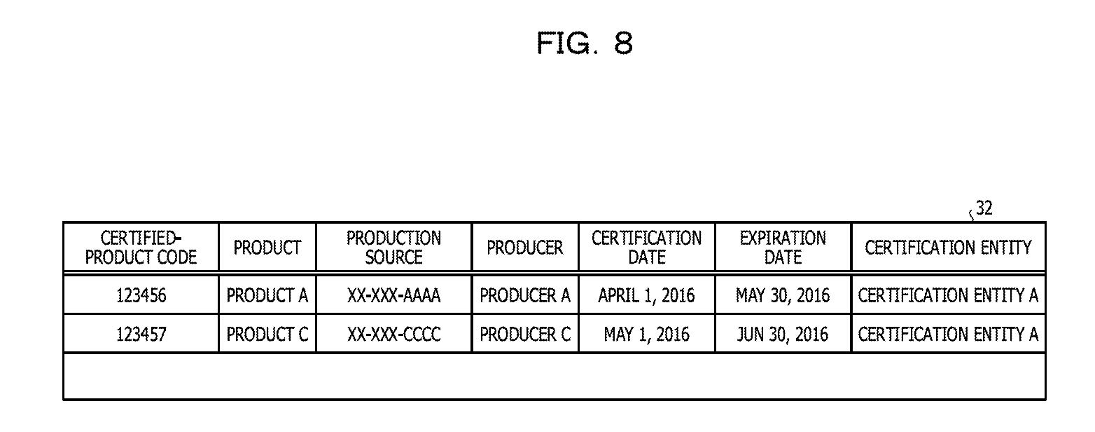

The certified-product information 32 is data for storing information on the products for which the benefit money has been made applicable. For example, in the certified-product information 32, the certified-product code, the producer, and other information are stored for every product for which the benefit money has been made applicable on payment. FIG. 8 is a diagram illustrating an example of the data structure of the certified-product information. As illustrated in FIG. 8, the certified-product information 32 has items such as “CERTIFIED-PRODUCT CODE”, “PRODUCT”, “PRODUCTION SOURCE”, “PRODUCER”, “CERTIFICATION DATE”, “EXPIRATION DATE”, and “CERTIFICATION ENTITY”. The items of the certified-product information 32 illustrated in FIG. 8 are examples, and the certified-product information 32 may have other items.

The item of “CERTIFIED-PRODUCT CODE” is an area for storing the certified-product code of the certified product. The item of “PRODUCT” is an area for storing information on the product certified as a certified product. The item of “PRODUCTION SOURCE” is an area for storing information indicating the production source of the product certified as a certified product. For the information indicating the production source, the same area code as that for the benefit area is used. In the item of “PRODUCTION SOURCE ”, the area code of the location of the production source of the product certified as a certified product is stored. The item of “PRODUCER” is an area for storing information on the producer of the product certified as a certified product. The item of “CERTIFICATION DATE” is an area for storing the date at which the product was certified as a certified product. The item of “EXPIRATION DATE” is an area for storing the expiration date of the certified product. The item of “CERTIFICATION ENTITY” is an area for storing the certification entity of the certified product. For example, in the example of FIG. 8, the certified-product code “123456” indicates that the product certified as a certified product is “PRODUCT A”, the production source is “XX-XXX-AAAA”, and the producer is “PRODUCER A”. The certified-product code “123456” also indicates that the certification date is Apr. 1, 2016, the expiration date is May 30, 2016, and the certification entity is “CERTIFICATION ENTITY A”.

Returning to FIG. 5, the control section 22 is a device that controls the settlement apparatus 13. For the control section 22, an electronic circuit, such as a central processing unit (CPU) or a micro processing unit (MPU), or an integrated circuit, such as an application specific integrated circuit (ASIC) or a field programmable gate array (FPGA), may be used. The control section 22 has internal memory for storing programs that specify various processing procedures and control data, which are used to execute various processes. The control section 22 functions as various processing sections by the various programs running. For example, the control section 22 has a receiving section 40, a determination section 41, and an output section 42, and a settlement section 43.

The receiving section 40 receives various operations. For example, when receiving an access from the store terminal 11 or the user terminal 12, the receiving section 40 transmits information for various operation screens to the access origin and lets the access origin display the operation screens. The receiving section 40 receives various operations by receiving control signals of the various operations through the operation screen.

For example, the receiving section 40 provides a website for services related to product settlement. When receiving an access to the website for a service related to product settlement from the store terminal 11, the receiving section 40 transmits information on a settlement operation screen to the store terminal 11, which is the access origin, and lets the store terminal 11 display the settlement operation screen. The receiving section 40 receives an inquiry about whether the benefit money is applicable to the payment for the product by receiving a control signal through the settlement operation screen, indicating an instruction for the inquiry about whether the benefit money is applicable to the payment for the product to be purchased. For example, the receiving section 40 receives registration of the product to be purchased through the settlement operation screen. For example, the receiving section 40 receives the certified-product code of the product to be purchased through the product registration screen.

For example, the receiving section 40 receives a request for settlement using a merchandise voucher from the store terminal 11 by receiving a control signal indicating the request for settlement using the merchandise voucher from the store terminal 11. For example, the receiving section 40 receives a request for settlement for which the certified-product code and the price of a product for the settlement and the information of the merchandise voucher to be used for the settlement are specified, by receiving a control signal through the settlement operation screen, indicating the request for settlement for which the certified-product code and the price of the product for the settlement and the information of the merchandise voucher to be used for the settlement are specified.

For example, the receiving section 40 receives an inquiry about an owned merchandise voucher by receiving a control signal indicating a request for the inquiry about the owned merchandise voucher. For example, when receiving an access from a consumer using the user terminal 12 with the identification information on the consumer himself/herself specified, the receiving section 40 transmits information on a merchandise voucher list screen displaying a list of the merchandise vouchers owned by the consumer to the access origin, and lets the user terminal 12, which is the access origin, display the merchandise voucher list screen. The receiving section 40 receives a selection operation for selecting a merchandise voucher to be used for the payment through the merchandise voucher list screen. When the merchandise voucher to be used for the payment is selected on the merchandise voucher list screen, the receiving section 40 transmits information on a payment screen for making payment using the selected merchandise voucher to the access origin, and lets the user terminal 12, which is the access origin, display the payment screen.

The determination section 41 makes various determinations in response to the requests received by the receiving section 40. For example, when the receiving section 40 receives an inquiry about whether a product to be purchased through the store terminal 11 is a product the payment for which the benefit money is applicable to, the determination section 41 determines whether it is a product the payment for which the benefit money is applicable to. For example, when the certified-product code of the product to be purchased is registered in the certified-product information 32, the determination section 41 determines that the benefit money is applicable to the payment for the product. In other words, for example, the determination section 41 determines whether use of the amount of the benefit money is permitted out of the amount of the merchandise voucher and the amount of the benefit money, based on the certified-product code of the product to be purchased.

For example, when receiving a request for settlement using a merchandise voucher from the store terminal 11, the determination section 41 determines whether the product to be purchased may be purchased using the premium of the merchandise voucher. For example, when receiving a request for settlement through the settlement operation screen, the determination section 41 determines the area code of the location of the production source from the certified-product code of the product to be purchased, based on the certified-product information 32. The determination section 41 also determines the area code of the benefit area to which the benefit money of the merchandise voucher to be used for the settlement is applicable, based on the merchandise voucher information 30. The determination section 41 determines whether the area code of the location of the production source of the product corresponds to the area code of the benefit area. When the area code of the location of the production source of the product agrees with the area code of the benefit area, the determination section 41 determines that the area code of the location of the production source of the product corresponds to the area code of the benefit area. When the location of the production source of the product is included in the benefit area, the determination section 41 may determines that the area code of the location the production source of the product corresponds to the area code of the benefit area. For example, when the small area “XX-XXX-AAAA” of the location of the production source of the product is included in the benefit area “XX-AAA-XXXX” in the master information, the determination section 41 determines that the area code of the location of the production source of the product corresponds to the area code of the benefit area. When the area code of the location of the production source of the product corresponds to the area code of the benefit area, the determination section 41 determines that the premium of the merchandise voucher may be used for the payment for the product to be purchased.

When receiving an inquiry about whether the benefit money is applicable to the payment for the product to be purchased through the store terminal 11, the output section 42 outputs the determination result. For example, the output section 42 outputs information on the determination result to the store terminal 11 and lets the store terminal 11 output the result to the user. For example, when receiving the certified-product code of the product to be purchased through the product registration screen, the output section 42 outputs the determination result about whether use of the amount of the benefit money is permitted for the product, on the product registration screen. For example, when there is benefit money permitted to the use, the output section 42 outputs the result indicating that the benefit money is applicable to the payment.

When receiving a request for settlement using a merchandise voucher from the store terminal 11, the settlement section 43 performs the settlement transaction for the purchase of the product using the amount permitted to be used. For example, when use of the benefit money is permitted, the settlement section 43 performs a settlement transaction for the purchase of the product, using first the benefit money out of the amount of the merchandise voucher and the benefit money. For example, when there is a remaining amount of the benefit money, the settlement section 43 first subtracts the payment for the product from the benefit money, and if all the payment of the product is not able to be subtracted from the benefit money, then subtracts the remaining of the payment from the balance of the merchandise voucher.

The settlement section 43 records transaction histories on cash vouchers in the issued merchandise voucher information 31. For example, the settlement section 43 increments the history number on the merchandise voucher used for settlement and registers the remaining amount after the payment for the product is subtracted and the remaining amount of the benefit money in the issued merchandise voucher information 31.

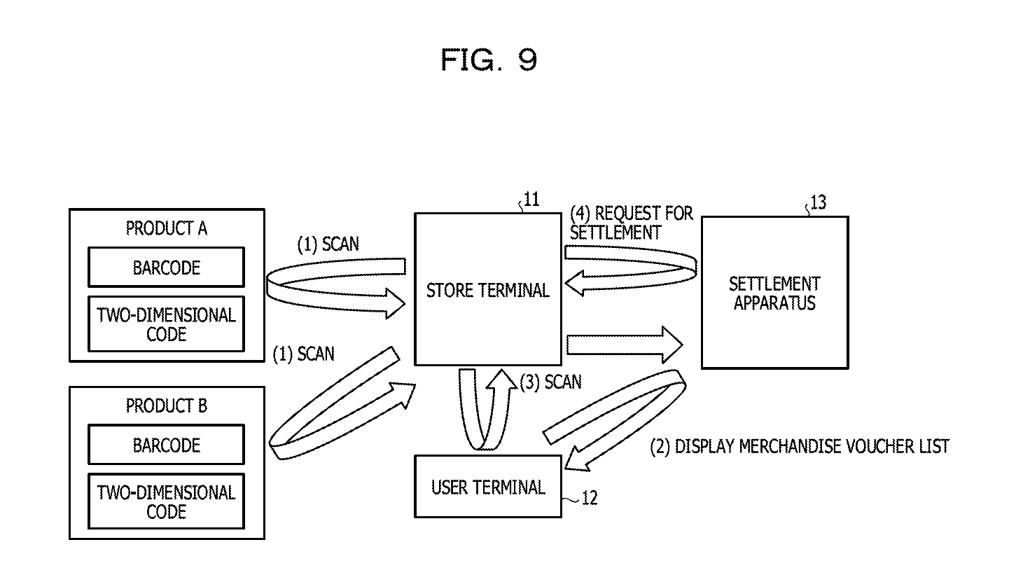

Using a specific example, description is provided for the flow of use of the premium merchandise voucher. FIG. 9 is a diagram schematically illustrating an example of the flow of purchase of a product using a premium merchandise voucher. The product has a barcode into which the product code or the like is encoded and a two-dimensional code into which the certified-product code is encoded. In the example of FIG. 9, products A and B each have the barcode and the two-dimensional code. The product code and the certified-product code may collectively be encoded into one two-dimensional code.

At the store terminal 11, the barcodes and two-dimensional codes on products A and B are scanned to register the products to be purchased on a settlement operation screen ((1) in FIG. 9).

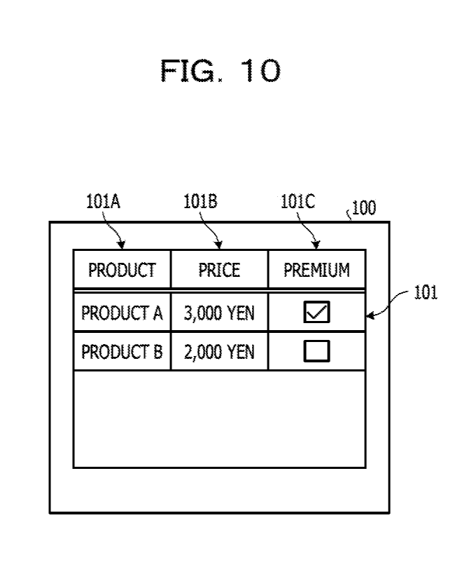

FIG. 10 is a diagram illustrating an example of the settlement operation screen. The example of FIG. 10 illustrates an example of the settlement operation screen displayed on the store terminal 11. The settlement operation screen 100 has a registered product area 101 for displaying information on registered products. The registered product area 101 has a product name area 101A for displaying the product name, a price area 101B for displaying the price of the product, and a premium area 101C for displaying the applicability of premium.

The registered product area 101 displays information on scanned products. The example of FIG. 10 illustrates the case where the barcodes and the two-dimensional codes on products A and B are scanned. The product name area 101A displays products A and B. The price area 101B displays the prices of products A and B.

For the products registered in the settlement operation screen 100, it is determined whether the benefit money is applicable for the payment of the products using the settlement apparatus 13. If the certified-product code of a products to be purchased has been registered in the certified-product information 32, the premium area 101C displays a check mark at the product indicating that the benefit money is applicable for the payment. In the example of FIG. 10, because product A is registered in the certified-product information 32, the premium area 101C of product A displays a check mark.

Returning to FIG. 9, a consumer purchases a product using a merchandise voucher. For example, the consumer accesses the settlement apparatus 13 using the user terminal 12. In response to the access from the user terminal 12, the settlement apparatus 13 displays a merchandise voucher list screen displaying the list of merchandise vouchers owned by the consumer ((2) in FIG. 9).

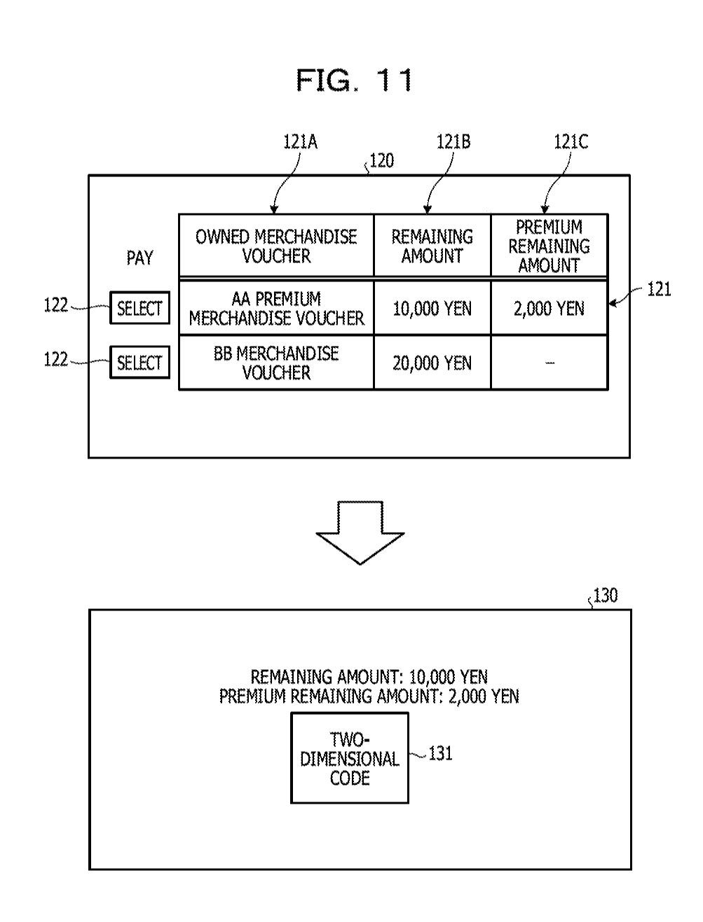

FIG. 11 is a diagram illustrating an example of merchandise voucher list screens. The example of FIG. 11 illustrates an example of merchandise voucher list screens displayed on the user terminal 12. The merchandise voucher list screen 120 has a merchandise voucher area 121 for displaying information on the merchandise vouchers owned by the consumer. The merchandise voucher area 121 has an owned merchandise voucher name area 121A for displaying owned merchandise voucher names, a remaining amount area 121B for displaying the remaining amount of the merchandise voucher, and a premium remaining amount area 121C displaying the remaining amount of the benefit money provided as the premium. The merchandise voucher list screen 120 has selection buttons 122 for selecting a merchandise voucher to be used for payment. Here, assume that the consumer is user A. In the example of FIG. 11, AA premium merchandise voucher and BB merchandise voucher are displayed as merchandise vouchers owned by user A. The consumer selects a selection button 122 corresponding to a merchandise voucher to be used for payment for the merchandise voucher list screen 120.

When the merchandise voucher to be used for payment is selected on the merchandise voucher list screen 120, the settlement apparatus 13 transmits information on a payment screen for payment using the selected merchandise voucher to the access origin and lets the user terminal 12, which is the access origin, display a payment screen 130. For example, the settlement apparatus 13 lets the user terminal 12 display a two-dimensional code 131, into which the type ID and the merchandise voucher ID of the selected merchandise voucher have been encoded, on the payment screen 130. The example of FIG. 11 illustrates the payment screen 130 in the case where AA premium merchandise voucher is selected on the merchandise voucher list screen 120. In the example of FIG. 11, the payment screen 130 also displays the remaining amount of the selected merchandise voucher and the remaining amount of the benefit money provided as the premium.

Returning to FIG. 9, the consumer presents the payment screen 130 when the consumer uses the merchandise voucher to purchase a product. At the store terminal 11, the two-dimensional code 131 displayed on the payment screen 130 is scanned and decoded to determine the type ID and the merchandise voucher ID of the merchandise voucher to be used for the settlement ((3) in FIG. 9). The certified-product code and the price of the product for the settlement and the type ID and the merchandise voucher ID of the merchandise voucher to be used for the settlement are specified through the store terminal 11, and a request for the settlement is sent to the settlement apparatus 13 ((4) in FIG. 9).

When receiving the request for settlement using the merchandise voucher from the store terminal 11, the settlement apparatus 13 determines whether the benefit money of the merchandise voucher may be used for the payment for the product to be purchased. when use of the benefit money is permitted, the settlement apparatus 13 performs settlement transaction for the purchase of the product, using first the benefit money out of the amount of the merchandise voucher and the benefit money. For example, when there is a remaining amount of the benefit money, the settlement apparatus 13 first subtracts the payment for the product from the benefit money, and if all the payment of the product is not able to be subtracted from the benefit money, then subtracts the remaining of the payment from the balance of the merchandise voucher. The settlement apparatus 13 records the transaction history on the cash voucher in the issued merchandise voucher information 31.

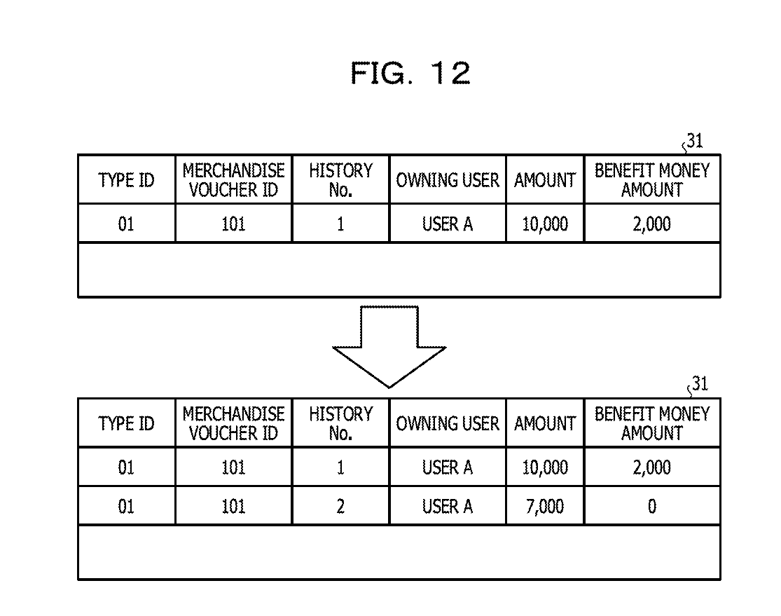

FIG. 12 is a diagram illustrating an example of recorded issued merchandise voucher information. The example of FIG. 12 illustrates the case where user A, the consumer, made payment using AA premium merchandise voucher with a type ID of “01”. In the example of FIG. 12, for AA premium merchandise voucher having a type ID of “01” and a merchandise voucher ID of “101”, the information stored as the history No. “1” indicates that the owning user is “USER A”, the balance of the merchandise voucher is “10,000” yen, and the balance of the benefit money is “2,000” yen. For example, when user A makes payment for products A and B illustrated in FIG. 10, since use of the benefit money is permitted for product A, 2,000 yen out of 3,000 yen is first paid from the benefit money, and the remaining 1,000 yen is paid from the remaining amount of the merchandise voucher. For product B, since use of benefit money is not permitted, 2,000 yen is paid from the remaining amount of the merchandise voucher. As a result, for the AA premium merchandise voucher with a type ID of “01” and a merchandise voucher ID of “101”, the information that the balance of the merchandise voucher is “7,000” yen, and the balance of benefit money is “0” is recorded as the history No. “2” in the issued merchandise voucher information 31.

Description has been provided for the case where if the area code of the location of the production source of the product corresponds to the area code of the benefit area, the determination section 41 determines that the benefit money is applicable for the payment. However, the embodiment is not limited to this case. For example, the determination section 41 may determines whether the benefit money is applicable for payment, based on product information and store information on the store where the product is purchased. For example, when the area code of the location of the production source of the product and location information indicating the location of the store where the product to be purchased correspond to the area code of the benefit area, the determination section 41 may determines that the benefit money is applicable for the payment. For the location information indicating the location of a store, the same area code as for the benefit area may be used. For example, the determination section 41 determines that the benefit money is applicable when the area code of the location of the production source of the product and the area code of the location of the store agree with the area code of the benefit area. The determination section 41 may determines that the benefit money is applicable when both the location of the production source of the product and the location of the store that sells the product are included in the benefit area. The location information indicating the locations of stores may be stored in the storage section 21 as the master information. Alternatively, the location information indicating the location of the store may be set in the store terminal 11, and the location information may be acquired from the store terminal 11. In other words, for example, defining that the benefit money is applicable when both the production source of a product and a store that sells the product are within the benefit area, the location information indicating the locations of stores may be associated with the production source information on the products and the store information on the stores that sell the products.

Judging that use of the benefit money is permitted when the certified-product code of the product to be purchased is registered in the certified-product information 32, the determination section 41 determines that the benefit money is applicable for the payment for the product. Although the description has been provided, as an example, for the case where the output section 42 outputs the information on whether the benefit money is applicable for the payment of the product, to the store terminal 11, the embodiment is not limited to this case. For example, the determination section 41 may determine that use of the benefit money is permitted when both the location of the production source of a product and the store that sells the product correspond to the benefit area.

[Process Flow]

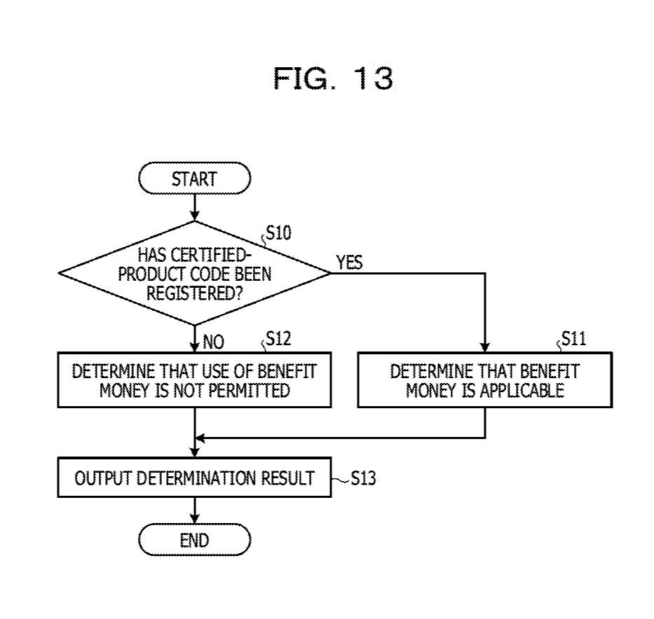

Next, description is provided for the flow of various processes executed by the settlement apparatus 13 according to this embodiment. First, the procedure of a determination process is described in which the settlement apparatus 13 determines whether the benefit money is applicable to the payment for a product. FIG. 13 is a flowchart illustrating the procedure of the determination process. The determination process illustrated in FIG. 13 is executed at a specified timing, for example, at the timing when the certified-product code of the product to be purchased is received through the product registration screen.

The determination section 41 determines whether the certified-product code of the product received through the product registration screen has been registered in the certified-product information 32 (S10). If the certified-product code is registered in the certified-product information 32 (Yes at S10), the determination section 41 determines that the benefit money is applicable to the payment for the product the certified-product code of which has been received through the product registration screen (S11). On the other hand, if the certified-product code is not registered in the certified-product information 32 (No at S10), the determination section 41 determines that use of the benefit money is not permitted for the payment for the product the certified-product code for which has been received through the product registration screen (S12).

The output section 42 outputs the determination result indicating whether use of the benefit money is permitted to the product, to the product registration screen and ends the process (S13).

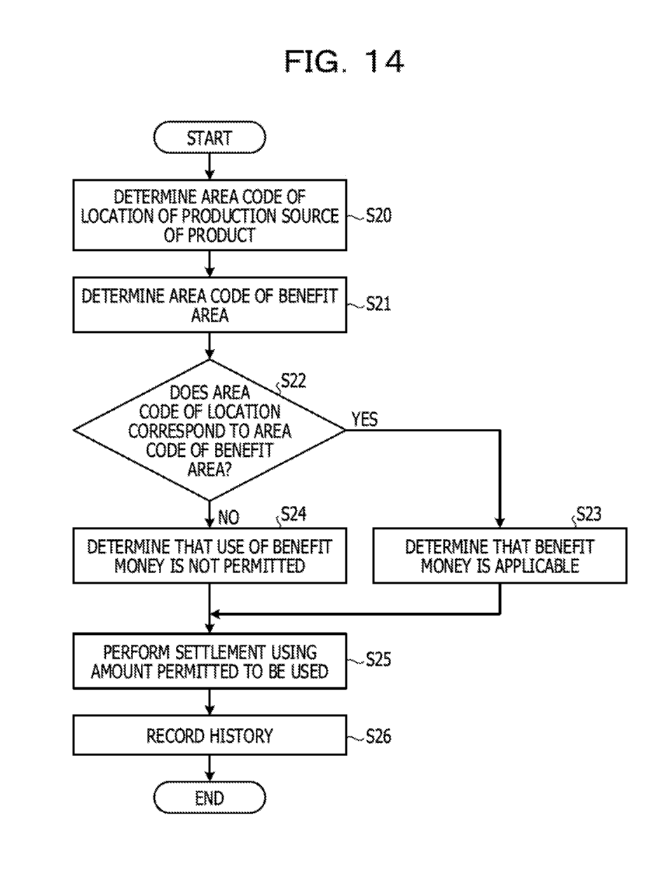

Next, the procedure of a settlement process is described in which the settlement apparatus 13 performs a settlement transaction using a merchandise voucher. FIG. 14 is a flowchart illustrating the procedure of the settlement process. The settlement process illustrated in FIG. 14 is executed at a specified timing, for example, at the timing of receiving, through the settlement operation screen, a request for settlement for which the certified-product code and the price of the product for the settlement and the information of the merchandise voucher to be used for the settlement are specified.

The determination section 41 determines the area code of the location of the production source of the product from the certified-product code of the product to be purchased, based on the certified-product information 32 (S20). The determination section 41 determines the area code of the benefit area to which the benefit money of the merchandise voucher used for the settlement is applicable, based on the merchandise voucher information 30 (S21). The determination section 41 determines whether the area code of the location of the production source of the product corresponds to the area code of the benefit area (S22). If the area code of the location of the production source of the product corresponds to the area code of the benefit area (Yes at S22), the determination section 41 determines that the benefit money of the merchandise voucher is applicable to the product to be purchased (S23). On the other hand, If the area code of the location of the production source of the product does not correspond to the area code of the benefit area (No at S22), the determination section 41 determines that use of the benefit money of the merchandise voucher is not permitted for the product to be purchased (S24).

The settlement section 43 performs a settlement transaction for the purchase of the product, using the amount permitted to be used (S25). For example, when use of the benefit money is permitted, the settlement section 43 performs a settlement transaction for the purchase of the product, using first the benefit money out the amount of the merchandise voucher and the benefit money.

The settlement section 43 records the transaction history on the cash voucher in the issued merchandise voucher information 31 (S26) and ends the process.

[Advantageous Effect]

The settlement apparatus 13 according to this embodiment determines the remaining amount to be used for the deduction transaction that is limited to the deduction transaction for specific products among multiple of balances, depending on the determination result about whether a product to be purchased through the store terminal 11 corresponds to one of the specific products. The settlement apparatus 13 executes a transaction to deduct the amount corresponding to the product to be purchased from the determined balance. This enables the settlement apparatus 13 to contribute to the promotion of the promotion target.

The settlement apparatus 13 stores multiple balances for each merchandise voucher. The settlement apparatus 13 receives a control signal specifying the merchandise voucher information on the merchandise voucher to be used for the settlement. The settlement apparatus 13 determines the remaining amount to be used for the deduction transaction that is limited to the deduction transaction for specific products, among multiple balances corresponding to the merchandise voucher in the merchandise voucher information. For example, the settlement apparatus 13 stores the remaining amount of the merchandise voucher and the remaining amount of the benefit money for each merchandise voucher as the multiple balances. When the product is a product to which the benefit money is applicable, the settlement apparatus 13 executes a deduction transaction for the product from the remaining amount of the benefit money. This process enables the settlement apparatus 13 to stimulate the purchase of the specific products and contribute to the promotion of the promotion target through sales of the specific products.

When determining that execution of a transaction to deduct the amount corresponding to the product to be purchased is not possible, the settlement apparatus 13 updates another balance among the multiple balances, from which the deduction transaction for the specific product is permitted, to execute a settlement transaction. For example, the settlement apparatus 13 stores the remaining amount of the merchandise voucher and the remaining amount of the benefit money for each merchandise voucher as multiple balances. When the settlement apparatus 13 is not able to execute the transaction to deduct the amount corresponding to the product to be purchased from the remaining amount of the benefit money, the settlement apparatus 13 executes a deduction transaction from the remaining amount of the merchandise voucher. This enables the settlement apparatus 13 to execute a settlement transaction even when the remaining amount of the benefit money is short of the amount corresponding to the product to be purchased.

The settlement apparatus 13 determines the remaining amount permitted to be used for the settlement on the product, based on the store information on the store at which the product is purchased. This enables the settlement apparatus 13 to contribute to the promotion of the store at which the product is purchased.

The settlement apparatus 13 determines that use of the benefit money is permitted when the production source information on the product and the location information on the store correspond to the information on the applicable area of the benefit money. This enables the settlement apparatus 13 to contribute to the promotion of the store and the production source of the product that produces the product in the applicable area of the benefit money.

The settlement apparatus 13 determines that use of the benefit money is permitted when the production source information on the product and the location information on the store correspond to the applicable area of the benefit money, regardless of the user's remaining amount information on the benefit money. The settlement apparatus 13 outputs the benefit money permitted to be used, to the user. This enables the settlement apparatus 13 to present the benefit money permitted to be used to the user regardless of the remaining amount of the benefit money. The settlement apparatus 13 performs a settlement transaction for the purchase of the product using first the benefit money that has a remaining amount, based on the remaining amount information on the benefit money that the user has specified among the outputted benefit money accounts and the benefit money of the user. This enables the settlement apparatus 13 to use the provided benefit money first for the purchase of the product and avoid the amount of the purchased merchandise voucher decreasing first.

Embodiment 2

Next, Embodiment 2 is described. The system 1 according to Embodiment 2 has the same configuration as Embodiment 1 illustrated in FIG. 1, and thus description thereof is omitted.

Giving benefit money according to Embodiment 2 is described. In Embodiment 2, local vendors pool funds together and give premiums to consumers who have come from the outside of the promoted region. In this embodiment, description is provided as an example for a foreign consumer who has come from a foreign country as a consumer who has come from the outside of the promoted region. In this embodiment, description is provided as an example for the case of giving benefit money that may be used in the promoted region as the premium. The premium may be loyalty points, such as points that may be used in the promoted region.

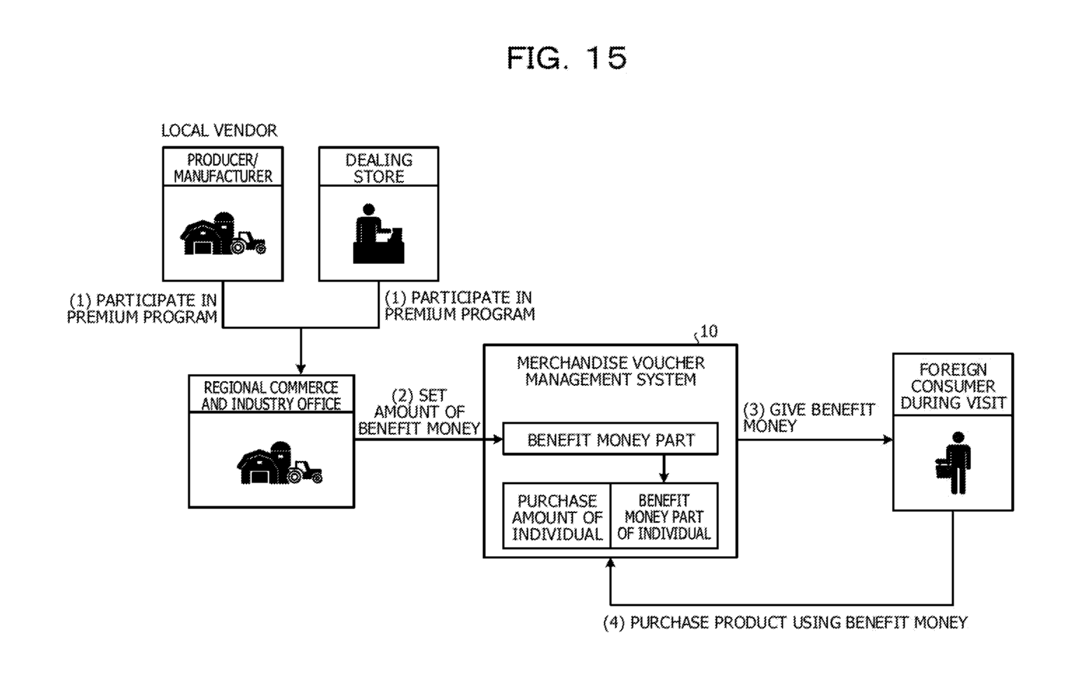

FIG. 15 is a diagram schematically illustrating the flow of the benefit money for the promoted region, according to Embodiment 2. For example, producers and manufacturers that produce products in the promoted region and local vendors such as dealing stores that deal with products of the promoted region participate in a premium program for giving the benefit money to foreign consumers who have come to the promoted region ((1) in FIG. 15). The premium program is operated by, for example, the regional commerce and industry office in the promoted region. The local vendors cooperate to pool the funds together. The regional commerce and industry office sets the funds cooperatively pooled as a benefit money part in the merchandise voucher management system 10 ((2) in FIG. 15). The merchandise voucher management system 10 sells merchandise vouchers as digital merchandise vouchers and manages the amount as electronic money for each foreign consumer. The merchandise voucher management system 10 manages provided benefit money as electronic money usable in the promoted region for each foreign consumer.

The benefit money is given to a foreign consumer in response to visits of the promoted region, use of local vendors in the promoted region, recommendation, and other activities ((3) in FIG. 15). For example, a foreign consumer installs a dedicated application in a user terminal 12 owned by the foreign consumer. The foreign consumer sets identification information on the foreign consumer into the dedicated application. The dedicated application notifies the merchandise voucher management system 10 of the set identification information of the foreign consumer as well as position information. When detecting that the foreign consumer is in a specific region of the promoted region, based on the position information in the notification, the merchandise voucher management system 10 gives benefit money to the foreign consumer. Beacons or the like are arranged at specific positions in the promoted region. When the merchandise voucher management system 10 is notified by the user terminal 12 via the dedicated application that the user terminal 12 has received information from a beacon, the merchandise voucher management system 10 gives benefit money to the foreign consumer using the user terminal 12. When the foreign consumer purchases a product at a store in a promotion target, the merchandise voucher management system 10 gives benefit money to the foreign consumer. Beacons are arranged at specific positions in the promoted region for delivering recommendation messages. The dedicated application has a function to post a received recommendation message to a social networking service (SNS). When the merchandise voucher management system 10 is notified by the user terminal 12 via the dedicated application that a received recommendation message has been posted on an SNS, the merchandise voucher management system 10 gives benefit money to the foreign consumer using the user terminal 12.

The foreign consumer uses the benefit money to purchase a product of the promoted region ((4) in FIG. 15).

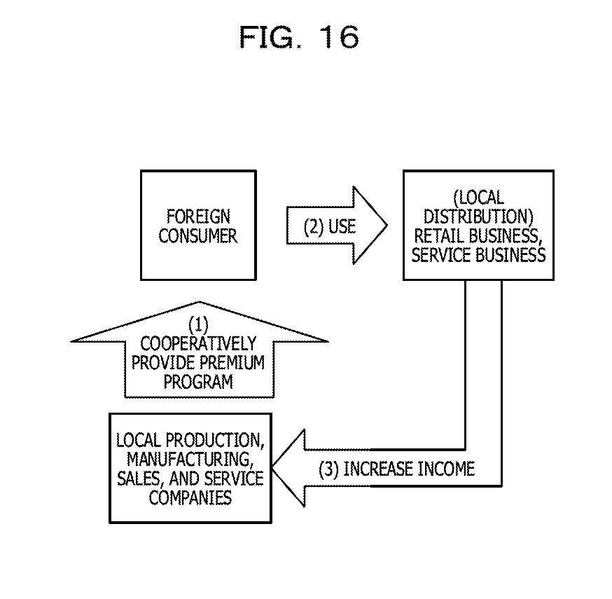

FIG. 16 is a diagram schematically illustrating the flow of use of the benefit money, according to Embodiment 2. Local vendors pool funds together and cooperatively provide the premium program for giving benefit money to foreign consumers visiting the promoted region ((1) in FIG. 16). The foreign consumer purchases a product of the promoted region at a store in the promoted region using provided benefit money ((2) in FIG. 16). This increases the sales volume of products and also the income at the stores in the promoted region ((3) in FIG. 16). Pooling the funds for the benefit money by using part of this increased income causes circulation of the economy of the promoted region, contributing to the promotion of the promotion target.

[Settlement Apparatus]

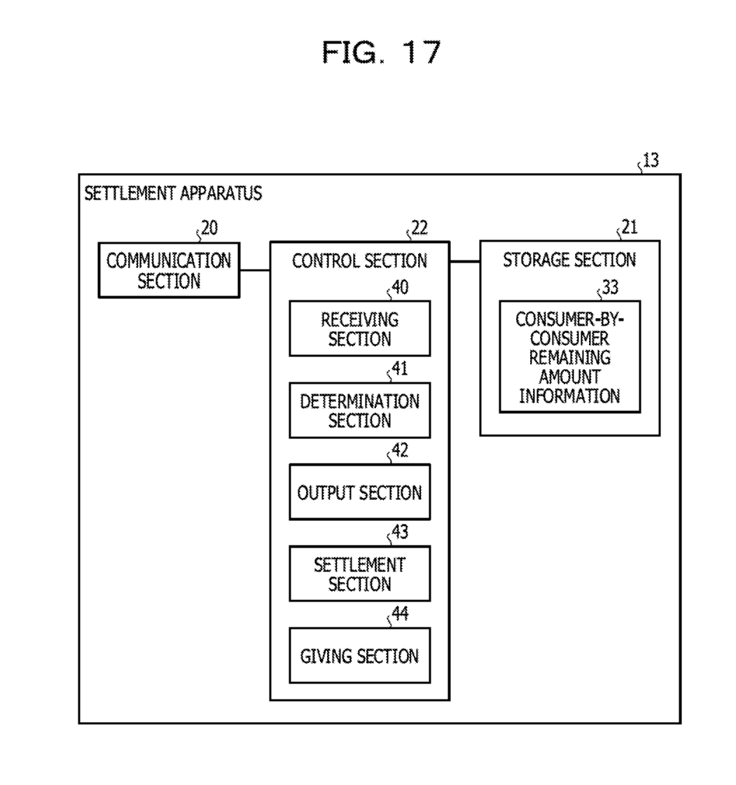

Next, description is provided for the configuration of a settlement apparatus 13 according to Embodiment 2. FIG. 17 is a diagram illustrating an example of the configuration of the settlement apparatus according to Embodiment 2. The settlement apparatus 13 according to Embodiment 2 has approximately the same configuration as that of Embodiment 1 illustrated in FIG. 5. Accordingly, the same parts are denoted by the same reference signs, and description is mainly provided for the differences.

As illustrated in FIG. 17, a storage section 21 stores consumer-by-consumer remaining amount information 33.

The consumer-by-consumer remaining amount information 33 is data for storing information on the remaining amount of electronic money for each consumer. For example, information stored in the consumer-by-consumer remaining amount information 33 includes the remaining amount of the electronic money sold as a digital merchandise voucher and the remaining amount of the provided benefit money is stored.

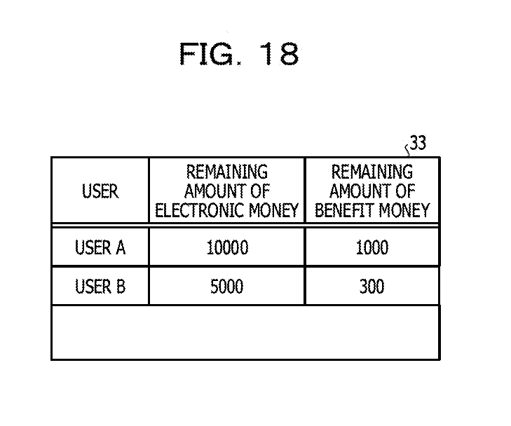

FIG. 18 is a diagram illustrating an example of the data structure of the consumer-by-consumer remaining amount information. As illustrated in FIG. 18, the consumer-by-consumer remaining amount information 33 has items, such as “USER”, “REMAINING AMOUNT OF ELECTRONIC MONEY”, and “REMAINING AMOUNT OF BENEFIT MONEY”. The items of the consumer-by-consumer remaining amount information 33 illustrated in FIG. 18 are examples, and the consumer-by-consumer remaining amount information 33 may have other items.

The item of “USER” is an area for storing the identification information of the consumer. The item of “REMAINING AMOUNT OF ELECTRONIC MONEY” is an area for storing the remaining amount of electronic money sold as a digital merchandise voucher. The item of “REMAINING AMOUNT OF BENEFIT MONEY” is an area for storing the remaining amount of the provided benefit money. For example, in the example of FIG. 18, the information stored for user A indicates that the remaining amount of the electronic money is “10,000” yen, and the remaining amount of the benefit money is “1,000” yen.

A control section 22 further includes a giving section 44.

The giving section 44 gives benefit money in response to a foreign consumer's visit to the promoted region, use of a local vendor in the promoted region, and recommendation.

A receiving section 40 provides a website for services on product settlement. When receiving an access to the website for services on product settlement from a store terminal 11, the receiving section 40 transmits information on a settlement operation screen to the store terminal 11, which is the access origin, and lets the store terminal 11 display the settlement operation screen. The receiving section 40 receives a request for settlement for which the price of the product for the settlement and the identification information on the foreign consumer requesting the settlement are specified, through the settlement operation screen.

When receiving the request for settlement, a settlement section 43 performs a settlement transaction for the purchase of the product, using the benefit money first out of the amount of the merchandise voucher and the benefit money. For example, when there is a remaining amount in the benefit money according to the consumer-by-consumer remaining amount information 33, the settlement section 43 first subtracts the payment for the product from the balance of the benefit money, and if all the payment of the product is not able to be subtracted from the benefit money, then subtracts the remaining of the payment from the remaining amount of the electronic money.

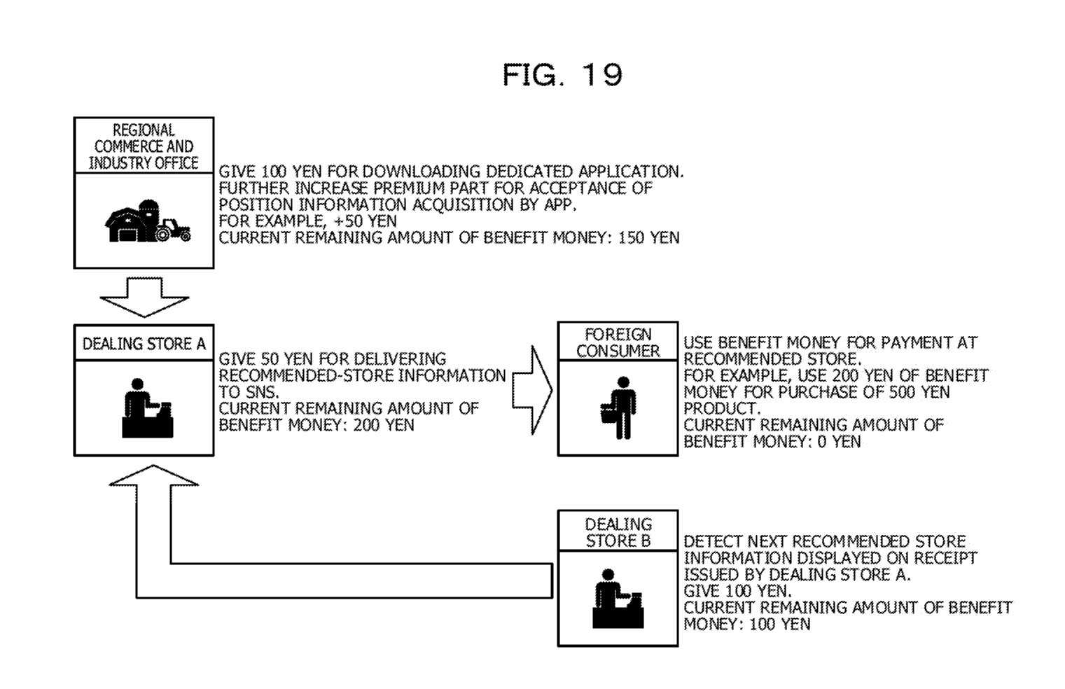

Using a specific example, the flows of giving benefit money is described. FIG. 19 is a diagram schematically illustrating an example of the flow of giving benefit money. For example, the settlement apparatus 13 gives 100 yen when the foreign consumer downloads and installs the dedicated application to his/her user terminal 12. When the user terminal 12 owned by the foreign consumer accepts the dedicated application to acquire position information, the settlement apparatus 13 further gives 50 yen. As a result, for example, when both benefits are given, the remaining amount of benefit money is now 150 yen.

For example, when the user terminal 12 posts to an SNS, information on a recommended store delivered from a beacon at a specific position in the promoted region, the settlement apparatus 13 gives 50 yen. As a result, for example, the remaining amount of benefit money is now 200 yen.

For example, when the foreign consumer makes payment at a recommended store using the benefit money, the settlement apparatus 13 subtracts the payment from the benefit money. For example, when the foreign consumer spends 200 yen from the benefit money for the purchase of a 500 yen product, the remaining amount of benefit money is now 0 yen.

For example, when a foreign consumer purchases a product at dealing store A, the receipt displays information on recommended stores, such as a link to the information on recommended stores. The receipt may be displayed as digital data on the dedicated application. When detecting a link to information on recommended stores on the dedicated application or the dedicated application displaying a digital receipt including information on recommended stores, the settlement apparatus 13 gives 100 yen. As a result, for example, the remaining amount of benefit money is now 100 yen. The foreign consumer visits a recommended store and does shopping using the benefit money, based on the information on the recommended stores.

Giving the benefit money as described above contributes promotion of the promotion target.

[Advantageous Effect]

The settlement apparatus 13 according to this embodiment stores multiple balances for the user identification information of each user. The settlement apparatus 13 receives a control signal specifying the user identification information of a user requesting settlement. The settlement apparatus 13 determines the remaining amount to be used for the deduction transaction that is limited to the deduction transaction for specific products, among multiple balances corresponding to the user indicated by the user identification information. For example, the settlement apparatus 13 stores the remaining amount of the electronic money and the remaining amount of the benefit money for each user as the multiple balances. When the product is a product to which the benefit money is applicable, the settlement apparatus 13 executes a deduction transaction for the product from the remaining amount of the benefit money. This process enables the settlement apparatus 13 to stimulate the purchase of specific products and contribute to the promotion of the promotion target through the sales of the specific products.

### Embodiment 3

Although the embodiments of the disclosed apparatuses have been described up to this point, the disclosed technique may be used in various different forms other than the embodiments described above. In the following, other embodiments included in this embodiment are described.

For example, in the above embodiments, the merchandise voucher information 30 stored in the storage section 21, the issued merchandise voucher information 31, and part or all of the certified-product information 32 and consumer-by-consumer remaining amount information 33 may be stored in an external storage apparatus communicably connected to the settlement apparatus 13.

In the above embodiments, the description has been provided, as an example, for the case where whether benefit money is applicable to the payment for a product to be purchased is determined based on whether the certified-product code of the product is registered in the certified-product information 32, and if there is benefit money permitted to be used for the payment, the information indicating that benefit money is applicable to the payment is outputted to the user. However, the embodiment is not limited to this case. For example, the determination section 41 further receives designation from a consumer on the merchandise voucher to be used for the purchase of a product. Then, as in the case of the settlement, the determination section 41 determines the area code of the location of the production source of the product from the certified-product code of the product to be purchased, based on the certified-product information 32. The determination section 41 determines the area code of the benefit area to which the benefit money of the merchandise voucher to be used for the settlement is applicable, based on the merchandise voucher information 30. The determination section 41 determines whether the area code of the location of the production source of the product corresponds to the area code of the benefit area. If the area code of the location of the production source of the product corresponds to the area code of the benefit area, the determination section 41 determines that the benefit money of the merchandise voucher to be used is applicable to the product to be purchased. The output section 42 may output information on the merchandise voucher permitted to be used, to the user. This enables the settlement apparatus 13 to send notification of whether the merchandise voucher to be used for the purchase of the product is applicable to the product to be purchased, before the settlement.

The determination section 41 may determine whether the benefit money of the merchandise voucher is applicable to the product to be purchased, only for the merchandise vouchers with benefit money having a remaining amount left.

In the above embodiments, the description has been provided, as an example, for the case where the benefit money of the merchandise voucher is used first to perform the settlement transaction for the purchase of the product. However, the embodiment is not limited to this case. For example, the receiving section 40 receives designation on the amount of the merchandise voucher to be used for the payment and the amount of the benefit money used for the payment, through the merchandise voucher list screen 120. When performing the settlement for the purchase of the product, the settlement section 43 may first use the amount, designated by the user, of the benefit money. For example, when the amount of the benefit money is 2,000 yen, and the amount designated by the user to be used for the payment from the benefit money is 1,000 yen, the settlement section 43 may first use the benefit money up to 1,000 yen designated by the user for the payment, and subtract the remaining of the payment from the merchandise voucher. This enables the user to designate the amount of the benefit money to be used for the purchase of a product on the settlement apparatus 13, and thus to use the benefit money according to the intention of the user.

In the above embodiments, the description has been provided, as an example, for the case where if there is benefit money permitted to be used, a check marks is presented to the user for indicating that the benefit money is applicable for the payment. However, the embodiment is not limited to this case. For example, if there is benefit money permitted to be used, the settlement apparatus 13 may present information such as the names of the merchandise vouchers having benefit money applicable to the payment. This enables the settlement apparatus 13 to let the user know the merchandise vouchers having benefit money applicable to the payment.

In the above embodiments, the description has been provided, as an example, for the case of determining whether the area code of the location of the production source of a product corresponds to the area code of the benefit area. However, the embodiment is not limited to this case. For example, the settlement apparatus 13 may permit use of benefit money in the case where it is determined whether the origin of the material included in the product corresponds to the area code of the benefit area, and the origin corresponds to the area code of the benefit area. Also in the case where products are plants or agricultural products, the settlement apparatus 13 may determine whether the origin of a product corresponds to the area code of the benefit area, and if the origin corresponds to the area code of the benefit area, the settlement apparatus 13 may permit use of the benefit money.

In the above embodiments, the description has been provided, as an example, for the case of determining which of the merchandise voucher and the benefit money are used for payment, based on product information on a product to be purchased. However, the embodiment is not limited to this case. For example, it may be determined which are used among multiple pieces of usable balance information, such as, the remaining amounts of multiple bank accounts and multiple credit card accounts, based on the product information on the product to be purchased. For example, the determination section 41 may choose a piece of remaining amount information that provides the largest benefit by the product to be purchased among multiple pieces of remaining amount information as a piece of remaining amount information permitted to be used for the settlement of the product. For example, when there are multiple credit card accounts as multiple pieces of remaining amount information, the determination section 41 determines which credit card provides the most points when used for the payment. The determination section 41 may determine the credit card that provides the most points as the credit cart to be used for the payment.

In the above embodiments, the description has been provided, as an example, for the case where the information on the products the payment for which the benefit money is applicable to is stored in the certified-product information 32. However, the embodiment is not limited to this case. For example, two-dimensional codes into which the information on products the payment for which benefit money is applicable to is encoded are attached to the products the payment for which benefit money is applicable to. At the store terminal 11, the two-dimensional code attached to the product to be purchased is scanned. the settlement apparatus 13 may decode the two-dimensional code scanned by the store terminal 11 to acquire the information on the product the payment for which benefit money is applicable to.

In the above embodiments, the description has been provided for the case where the settlement apparatus 13 transmits information on various operation screens to the store terminal 11 and the user terminal 12 and lets the store terminal 11 and the user terminal 12 display the operation screens. However, the embodiment is not limited to this case. For example, dedicated applications may be installed and operated in the store terminal 11 and the user terminal 12, and the above functions may be cooperatively achieved with the dedicated applications running in the store terminal 11 and the user terminal 12.

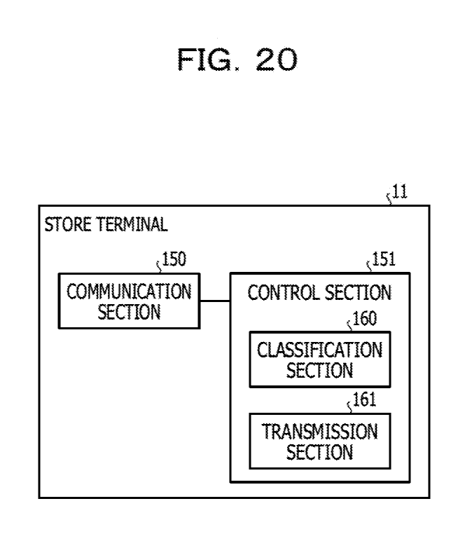

Description is provided for the case where the function of making a request for settlement is implemented in a dedicated application in the store terminal 11. The configuration of the store terminal 11 is as follows. FIG. 20 is a diagram illustrating an example of the configuration of a store terminal. As illustrated in FIG. 20, a store terminal 11 has a communication section 150 and a control section 151.

The communication section 150 is an interface that performs communication control between the store terminal 11 and other apparatuses. The communication section 150 transmits and receives various kinds of information to and from other apparatuses via a network N. For the communication section 150, a network interface card, such as a LAN card, may be used.

The control section 151 is a device that controls the store terminal 11. For the control section 151, an electronic circuit, such as a CPU or an MPU, or an integrated circuit, such as an ASIC or an FPGA, may be used. The control section 151 has internal memory for storing programs that specify various processing procedures and control data, which are used to execute various processes. The control section 151 functions as various processing sections by the various programs running. For example, the control section 151 has a classification section 160 and a transmission section 161.

The transmission section 161 transmits control signals for various operations to the settlement apparatus 13. For example, the transmission section 161 transmits a control signal for giving an instructing on an inquiry about whether the benefit money is applicable for the payment for the product to be purchased through the settlement operation screen. For example, the transmission section 161 also transmits a control signal for making a request for settlement for which the certified-product code and the price of the product for the settlement and the information of the merchandise voucher to be used for the settlement are specified. For example, depending on the determination result about whether the product to be purchased corresponds to one of the specific products, the transmission section 161 transmits a control signal specifying a specific piece of balance management information to be used for a deduction transaction limited to the deduction transaction for specific products, out of multiple pieces of balance management information, as an object from which the amount corresponding to the product to be purchased is deducted.

The store terminal 11 may classify multiple products to be purchased into the products the payment for which the benefit money is applicable to and the products they payment for which the benefit money is not applicable to, and may transmit a control signal for requesting for settlement on each product group. For example, the classification section 160 classifies multiple products to be purchased into a first group of products to be purchased for which the deduction transaction is permitted according to the first balance management information and a second group of products to be purchased for which the deduction transaction is not permitted according to the first balance management information, but the deduction transaction is permitted according to second balance management information. The transmission section 161 may transmit a signal for requesting the purchase amount on the first product group to be settled using the first balance management information and the purchase amount on the second product group to be settled using the second balance management information. The settlement apparatus 13 may settle the purchase amount on the first product group using the first balance management information and settle the purchase amount on the second product group using the second balance management information.

The functions of the illustrated constituents of each apparatus are conceptual, which means these constituents are not necessarily physically configured as in the illustration. In other words, for example, the concrete structure of each apparatus in terms of separation and integration is not limited to the ones illustrated in the figures. All or part of the apparatus may be configured separately or integrally in terms of functions or physical partitions on an arbitrary basis depending on various loads and usage conditions. For example, the processing sections of the receiving section 40, determination section 41, output section 42, settlement section 43, and giving section 44 of the settlement apparatus 13 may be integrated or separated as appropriate. The processing sections of the classification section 160 and transmission section 161 of the store terminal 11 may be integrated or separated as appropriate. All or any part of the processing functions performed by the processing sections of the settlement apparatus 13 and the store terminal 11 may be implemented by a CPU and a program analyzed and executed by the CPU, or may be implemented as hardware using wired logic circuits.

[Settlement Program]

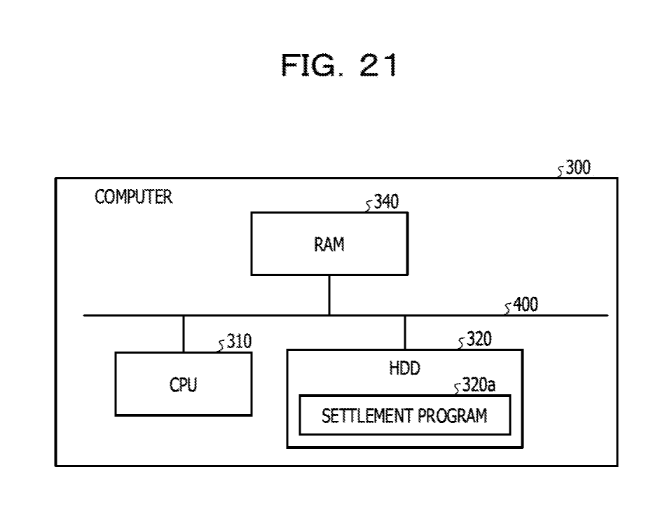

Various processes described in the above embodiments may be performed by executing a program prepared in advance on a computer system, such as a personal computer or a work station. Thus, in the following, description is provided for an example of a computer system that executes a program having the same function as the above embodiments. FIG. 21 is a diagram illustrating a computer that executes a settlement program.

As illustrated in FIG. 21, a computer 300 has a CPU 310, a hard disk drive (HDD) 320, and a random access memory (RAM) 340. These units 310 to 340 are connected to one another via a bus 400.

The HDD 320 stores in advance a settlement program 320a serving as the same functions as the processing sections of the settlement apparatus 13 in the above embodiments. For example, the stored settlement program 320a serves as the same functions as the receiving section 40, determination section 41, output section 42, settlement section 43, and giving section 44 in the above embodiments. The settlement program 320a may be separated as appropriate.

The HDD 320 also stores various kinds of data. For example, the HDD 320 stores the OS and various kinds of data.

The CPU 310 reads the settlement program 320a from the HDD 320 and executes the settlement program 320a to perform the same operations as the receiving section 40, determination section 41, output section 42, settlement section 43, and giving section 44 in the embodiments. In other words, for example, the settlement program 320a performs the same operations as the receiving section 40, determination section 41, output section 42, settlement section 43, and giving section 44 in the embodiments.

[Settlement Request Program]

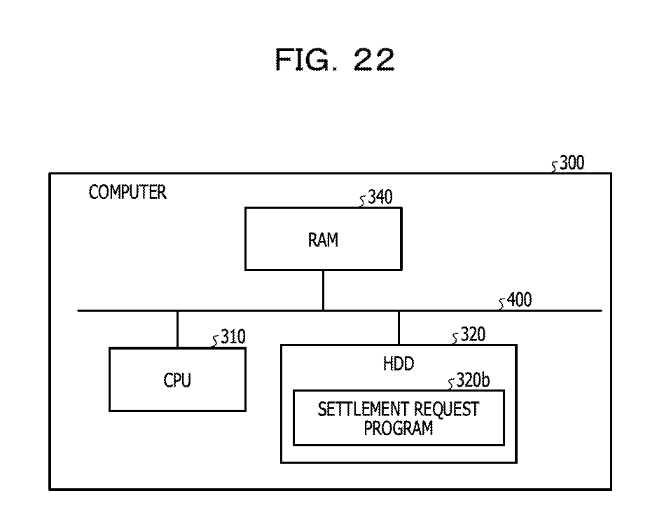

Next, descriptions is provided for a settlement request program for performing a settlement request process. FIG. 22 is a diagram illustrating a computer that executes a settlement request program. The same parts as in FIG. 21 are denoted by the same reference signs, and descriptions of those parts are omitted.

As illustrated in FIG. 22, the HDD 320 stores in advance a settlement request program 320b serving as the same functions as the processing sections of the store terminal 11 in the above embodiments. For example, the stored settlement request program 320b serves as the same functions as the classification section 160 and transmission section 161 in the above embodiment. The settlement request program 320b may be separated as appropriate.

The HDD 320 also stores various kinds of data. For example, the HDD 320 stores the OS and various kinds of data.

The CPU 310 reads the settlement request program 320b from the HDD 320 and executes the settlement request program 320b to perform the same operations as the classification section 160 and transmission section 161 in the embodiment. In other words, for example, the settlement request program 320b performs the same operations as the classification section 160 and transmission section 161 in the embodiment.

The above settlement program 320a and settlement request program 320b are not necessarily stored in the HDD 320 in the initial state. For example, the programs are stored in a “portable physical medium”, such as a flexible disk (FD), a Compact Disk Read Only Memory (CD-ROM), and a Digital Versatile Disk (DVD), a magneto-optical disk, and an IC card, which are inserted into the computer 300. The computer 300 may read these programs from the medium to execute the programs.

The programs may be stored “another computer (or a server)” or the like connected to the computer 300 via a public line, the Internet, a LAN, a WAN, or the like. The computer 300 may read the programs from it to execute the programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium recording a settlement program for causing a computer to execute a process, the process comprising:
receiving, from an information processing terminal, a control signal that specifies, depending on a determination result about whether a product to be purchased corresponds to a specific product, a specific piece of balance management information to be used for a deduction transaction for the specific product, as a deduction transaction target to deduct an amount corresponding to the product to be purchased from among multiple pieces of balance management information;
determining a piece of balance management information identified based on the received control signal, by referring to a storage which stores the multiple pieces of balance management information; and
executing a deduction transaction for the amount corresponding to the product to be purchased, using the determined piece of balance management information.

2. The non-transitory computer-readable recording medium according to claim 1, wherein
the control signal includes user identification information, and
the piece of balance management information identified based on the received control signal is determined out of multiple pieces of balance management information corresponding to the user identification information, by referring to the storage which stores the multiple pieces of balance management information on a user identification information piece basis.

3. The non-transitory computer-readable recording medium according to claim 1, wherein the process includes:
executing, when it is determined that the deduction transaction for the amount corresponding to the product to be purchased is not able to be executed using the determined piece of balance management information, a settlement transaction by updating another piece of balance management information on which a deduction transaction for the specific product is permitted, from among the multiple pieces of balance management information.

4. The non-transitory computer-readable recording medium according to claim 1, wherein
the control signal is information generated based on origin information or production source information on the specific product, and
the multiple pieces of balance management information are information associated with the origin information or the production source information.

5. The non-transitory computer-readable recording medium according to claim 1, wherein
the control signal is information generated based on origin information or production source information on the specific product, and store information on a store at which the specific product is purchased, and
the multiple pieces of balance management information are information associated with the origin information or the production source information and the store information.

6. A non-transitory computer-readable recording medium recording a settlement program for causing a computer to execute a process, the process comprising:
classifying multiple products to be purchased into a first group of products to be purchased on which a deduction transaction is permitted according to first balance management information included in multiple pieces of balance management information and a second group of products to be purchased on which the deduction transaction is not permitted according to the first balance management information and the deduction transaction is permitted according to second balance management information included in the multiple pieces of balance management information; and
transmitting a signal that requests to execute a settlement of a first purchase amount of the first group of the products to be purchased using the first balance management information and execute a settlement of a second purchase amount of the second group of the products to be purchased using the second balance management information.

7. The non-transitory computer-readable recording medium according to claim 6, wherein
the multiple pieces of balance management information is managed on a user identification information piece basis.

8. The non-transitory computer-readable recording medium according to claim 6, wherein
the multiple pieces of balance management information are information associated with origin information or production source information on the multiple products.

9. The non-transitory computer-readable recording medium according to claim 6, wherein
the multiple pieces of balance management information are information associated with origin information or production source information on the multiple products and the store information on a store at which one or more products of the first group and the second group are purchased.

10. A non-transitory computer-readable recording medium recording a settlement program for causing a computer to execute a process, the process comprising:
receiving, from an information processing apparatus, a determination result about whether a product to be purchased corresponds to a specific product; and
transmitting a control signal that specifies, depending on the determination result, a specific piece of balance management information to be used for a deduction transaction for the specific product, as a deduction transaction target to deduct an amount corresponding to the product to be purchased from among multiple pieces of balance management information to the information processing apparatus.

11. The non-transitory computer-readable recording medium according to claim 10, wherein
the control signal includes user identification information, and
the piece of balance management information identified based on the received control signal is determined out of multiple pieces of balance management information corresponding to the user identification information, by referring to the storage which stores the multiple pieces of balance management information on a user identification information piece basis.

12. The non-transitory computer-readable recording medium according to claim 10, wherein
the control signal is information generated based on origin information or production source information on the specific product, and
the multiple pieces of balance management information are information associated with the origin information or the production source information.

13. The non-transitory computer-readable recording medium according to claim 10, wherein
the control signal is information generated based on origin information or production source information on the specific product, and store information on a store at which the specific product is purchased, and
the multiple pieces of balance management information are information associated with the origin information or the production source information and the store information.
